(19) United States
(12) Patent Application Publication
(10) Pub. No.: US 2024/0334006 A1
(43) Pub. Date: Oct. 3, 2024

(54) METHOD, APPARATUS, AND MEDIUM FOR MEDIA DATA TRANSMISSION

(71) Applicants: Beijing Bytedance Network Technology Co., Ltd., Beijing (CN); Bytedance Inc., Los Angeles, CA (US)

(72) Inventors: Yongyi YU, Beijing (CN); Jianping Chen, Beijing (CN); Ye-Kui Wang, Los Angeles, CA (US); Chuanchuan Du, Beijing (CN)

(21) Appl. No.: 18/737,709

(22) Filed: Jun. 7, 2024

Related U.S. Application Data
(63) Continuation of application No. PCT/CN2022/137116, filed on Dec. 7, 2022.

(30) Foreign Application Priority Data
Dec. 7, 2021 (WO) PCT/CN2021/136078

(51) Int. Cl. H04N 21/438; H04N 21/2187; H04N 21/435; H04N 21/437; H04N 21/858

(52) U.S. Cl. CPC H04N 21/4384; H04N 21/2187; H04N 21/435; H04N 21/437; H04N 21/8586

(57) ABSTRACT

Embodiments of the present disclosure provide a solution for media data transmission. A method for media data transmission is proposed. The method comprises: transmitting, at a first device and to a second device, a request for at least one media data file, the request comprising a first indication indicating that a plurality of media data files are to be transmitted in a single message; and receiving the plurality of media data files in the single message from the second device. Thereby, the initialization delay can be advantageously reduced.

CROSS REFERENCE

This application is a continuation of International Application No. PCT/CN2022/137116, filed on Dec. 7, 2022, which claims the benefit of International Application No. PCT/CN2021/136078 filed on Dec. 7, 2021. The entire contents of these applications are hereby incorporated by reference in their entireties.

### FIELD

Embodiments of the present disclosure relates generally to video streaming techniques, and more particularly, to tuning in delay optimization in live media streaming.

### BACKGROUND

Media streaming applications are typically based on the internet protocol (IP), transmission control protocol (TCP), and hypertext transfer protocol (HTTP) transport methods, and typically rely on a file format such as the ISO base media file format (ISOBMFF). One such streaming system is dynamic adaptive streaming over HTTP (DASH). In Dynamic adaptive streaming over HTTP (DASH), there may be multiple representations for video and/or audio data of multimedia content, different representations may correspond to different coding characteristics (e.g., different profiles or levels of a video coding standard, different bitrates, different spatial resolutions, etc.). With live streaming services becoming more and more popular, enhancement on DASH is required.

### SUMMARY

Embodiments of the present disclosure provide a solution for media data transmission.

In a first aspect, a method for media data transmission is proposed. The method comprises: transmitting, at a first device and to a second device, a request for at least one media data file, the request comprising a first indication indicating that a plurality of media data files are to be transmitted in a single message; and receiving the plurality of media data files in the single message from the second device.

Based on the method in accordance with the first aspect of the present disclosure, a plurality of media data files for presenting media content to a user can be received in a single message. Compared with the conventional solution where these media data files are requested and transmitted in more than one roundtrip, the proposed method can advantageously reduce the roundtrips and thus the initialization delay can be reduced.

In a second aspect, another method for media data transmission is proposed. The method comprises: receiving, at a second device and from a first device, a request for at least one media data file, the request comprising a first indication indicating that a plurality of media data files are to be transmitted in a single message; and transmitting the plurality of media data files in the single message to the first device.

Based on the method in accordance with the second aspect of the present disclosure, a plurality of media data files for presenting media content to a user can be transmitted in a single message. Compared with the conventional solution where these media data files are requested and transmitted in more than one roundtrip, the proposed method can advantageously reduce the roundtrips and thus the initialization delay can be reduced.

In a third aspect, an apparatus for processing video data is proposed. The apparatus for processing video data comprises a processor and a non-transitory memory with instructions thereon. The instructions, upon execution by the processor, cause the processor to perform a method in accordance with the first or second aspect of the present disclosure.

In a fourth aspect, a non-transitory computer-readable storage medium is proposed. The non-transitory computer-readable storage medium stores instructions that cause a processor to perform a method in accordance with the first or second aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4A is a schematic diagram illustrating a first part of an example of a DASH Tuning-In Method response;

FIG. 4B is a schematic diagram illustrating a second part of the example of the DASH Tuning-In Method response;

FIG. 5A is a schematic diagram illustrating a first part of an example process of the DASH Tuning-In Method using a content delivery network (CDN) when the needed files are not cached;

FIG. 5B is a schematic diagram illustrating a second part of the example process of the DASH Tuning-In Method using the CDN when the needed files are not cached;

FIG. 5C is a schematic diagram illustrating a third part of the example process of the DASH Tuning-In Method using the CDN when the needed files are not cached;

FIG. 5D is a schematic diagram illustrating a fourth part of the example process of the DASH Tuning-In Method using the CDN when the needed files are not cached;

FIG. 6 illustrates a schematic diagram of an example environment in which techniques for media data transmission in accordance with some embodiments of the present disclosure can be implemented;

FIG. 7 illustrates a signaling chart for media data transmission according to some embodiments of the present disclosure;

FIG. 8 illustrates another signaling chart for media data transmission according to some embodiments of the present disclosure;

FIG. 9 illustrates a flowchart of a method of media data transmission in accordance with some embodiments of the present disclosure;

FIG. 10 illustrates a flowchart of another method of media data transmission in accordance with some embodiments of the present disclosure; and

FIG. 11 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

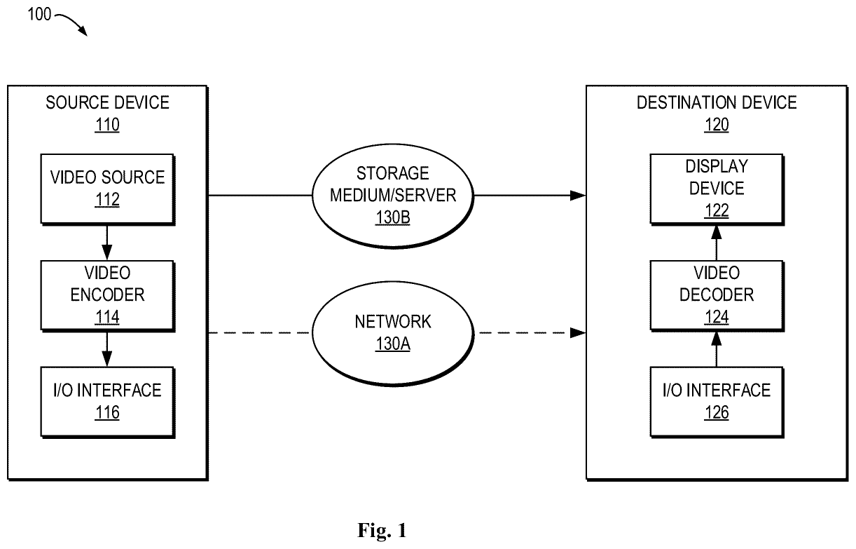

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

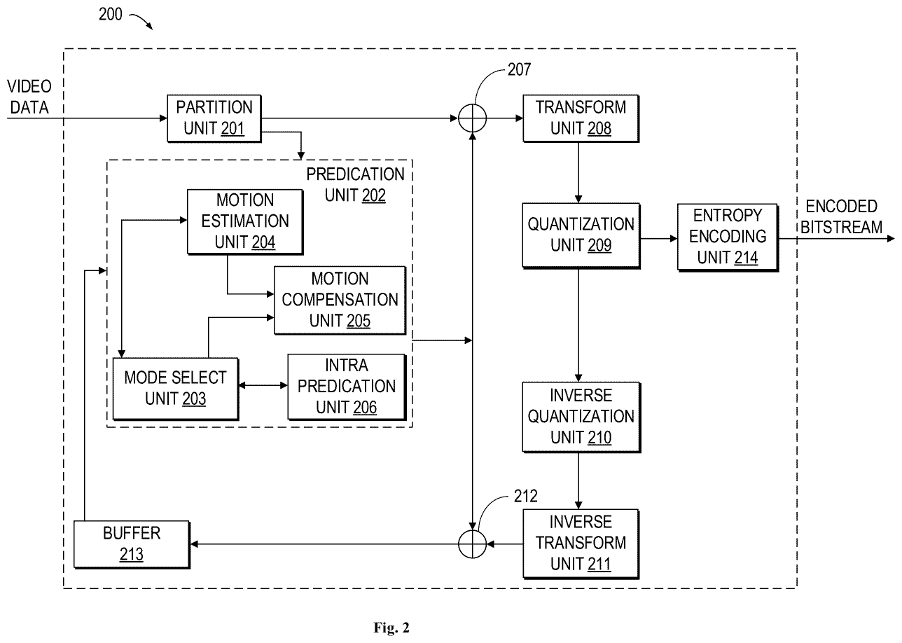

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

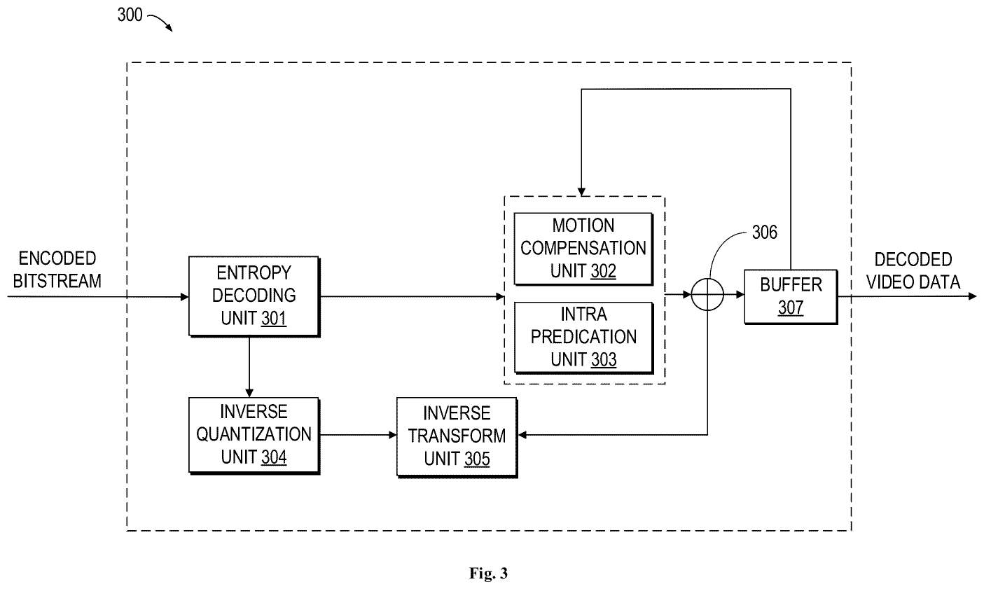

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. SUMMARY

This disclosure is related to video streaming. Specifically, it is related to the definition of some new HTTP header extensions for minimizing the initialization delay (i.e., tune in delay) in live media streaming. The ideas may be applied individually or in various combinations, for media streaming systems, e.g., based on the Dynamic Adaptive Streaming over HTTP (DASH) standard or its extensions.

### 2. BACKGROUND

### 2.1 Video Coding Standards

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. Since then, many new methods have been adopted by JVET and put into the reference software named Joint Exploration Model (JEM). The JVET was later renamed to be the Joint Video Experts Team (JVET) when the Versatile Video Coding (VVC) project officially started. VVC is the new coding standard, targeting at 50% bitrate reduction as compared to HEVC, that has been finalized by the JVET at its 19th meeting ended at Jul. 1, 2020.

The Versatile Video Coding (VVC) standard (ITU-T H.266|ISO/IEC 23090-3) and the associated Versatile Supplemental Enhancement Information (VSEI) standard (ITU-T H.274|ISO/IEC 23002-7) have been designed for use in a maximally broad range of applications, including both the traditional uses such as television broadcast, video conferencing, or playback from storage media, and also newer and more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard that has recently been developed by MPEG.

### 2.2 File Format Standards

Media streaming applications are typically based on the IP, TCP, and HTTP transport methods, and typically rely on a file format such as the ISO base media file format (ISOBMFF). One such streaming system is dynamic adaptive streaming over HTTP (DASH). For using a video format with ISOBMFF and DASH, a file format specification specific to the video format, such as the AVC file format and the HEVC file format, would be needed for encapsulation of the video content in ISOBMFF tracks and in DASH representations and segments. Important information about the video bitstreams, e.g., the profile, tier, and level, and many others, would need to be exposed as file format level metadata and/or DASH media presentation description (MPD) for content selection purposes, e.g., for selection of appropriate media segments both for initialization at the beginning of a streaming session and for stream adaptation during the streaming session.

Similarly, for using an image format with ISOBMFF, a file format specification specific to the image format, such as the AVC image file format and the HEVC image file format, would be needed.

The VVC video file format, the file format for storage of VVC video content based on ISOBMFF, is currently being developed by MPEG.

The VVC image file format, the file format for storage of image content coded using VVC, based on ISOBMFF, is currently being developed by MPEG.

### 2.3 DASH

In Dynamic adaptive streaming over HTTP (DASH), there may be multiple representations for video and/or audio data of multimedia content, different representations may correspond to different coding characteristics (e.g., different profiles or levels of a video coding standard, different bitrates, different spatial resolutions, etc.). The manifest of such representations may be defined in a Media Presentation Description (MPD) data structure. A media presentation may correspond to a structured collection of data that is accessible to DASH streaming client device. The DASH streaming client device may request and download media data information to present a streaming service to a user of the client device. A media presentation may be described in the MPD data structure, which may include updates of the MPD.

A media presentation may contain a sequence of one or more periods. Each period may extend until the start of the next Period, or until the end of the media presentation, in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period. A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

A typical DASH streaming procedure is shown by the following steps:
1) The client gets the MPD.
2) The client estimates the downlink bandwidth, and selects a video representation and an audio representation according to the estimated downlink bandwidth and the codec, decoding capability, display size, audio language setting, etc.
3) Unless the end of the media presentation is reached, the client requests media segments of the selected representations and presents the streaming content to the user.
4) The client keeps estimating the downlink bandwidth. When the bandwidth changes to a direction (e.g., becomes lower) significantly, the client selects a different video representation to match the newly estimated bandwidth, and go to step 3.

### 3. PROBLEMS

In live streaming based on DASH, particularly when the live “broadcasters” are users using all kinds of mobile devices, it is often difficult to ensure constant Segment durations. The video camera of the device may capture video at different varying frame rates. The video encoder may skip a frame from time to time due to computing resource issues. Therefore, it is not always possible to use the simple and nice approach based on the @duration attribute that specifies the constant approximate Segment duration. Consequently, many live streaming services are forced to use the SegmentTimeline element. However, using SegmentTimeline often requires a client to request the latest MPD whenever tuning into a live streaming session. Basically, the client firstly requests the latest MPD to obtain the URL information of the latest Media Segment, then it requests the Initialization Segment and the latest Media Segment and continues from there. This need of multiple roundtrips and multiple requests causes additional initialization delay (the delay between the time moments when a user presses the “Start” /“Join” button and when the first picture is displayed) compared to the case when it is possible to use the @duration attribute and the $number$-identifier-based URL template for Segments.

### 4. DETAILED SOLUTIONS

To solve the above-described problem, methods as summarized below are disclosed. The solutions should be considered as examples to explain the general concepts and should not be interpreted in a narrow way. Furthermore, these solutions can be applied individually or combined in any manner. For convenience, each object, e.g., an MPD, an Initialization Segment (IS), a Media Segment (MS), is referred to as a file in the description below.

To solve the above problem, one or more of the following methods are disclosed:
1) A new way for client to tune into a live streaming session, named the DASH Tuning-In Method is defined.
   a. As a client, when the DASH Tuning-In Method is enabled, it notifies the server that it enables this method when requesting the MPD file, e.g., by including a specific HTTP header within the request. If the client gets a confirmation that the server also enables the DASH Tuning-In Method, the client parses an MIME multipart message sent by the server, reads files within the different parts of the MIME multipart message, and uses those files to initialize the player and start playing.
   b. As a server, when the DASH Tuning-In Method is enabled, it sends the requested MPD file and all other files a client needs to tune into the live streaming session with a single response, by using a MIME multipart message. The server may include multiple files into the MIME multipart message as different parts of the message, e.g., an MPD, one or more ISs, and one or more MSs.
      i. In one example, when using a CDN, the MIME multipart message should be generated by the CDN's edge server instead of the origin server. When generating the MIME multipart message, the edge server should load needed files from its cache and only request those files from the origin server that are absent.
         1. In one example, additionally, when sending the MPD file in an HTTP response to the CDN, the origin server may notify the CDN what files should be included in the MIME multipart message to be sent from the CDN to the client, e.g., by including the URLs of the files in the HTTP response header.
         2. In one example, additionally, the origin server may notify the CDN the type of the file when sending a file to the CDN in an HTTP response, e.g., by including the type of the file in the HTTP response header.
         3. In on example, additionally, the origin server may notify the CDN what identifiers are used to construct the URL of the file when sending a file to the CDN in an HTTP response, e.g., by including the identifiers in the HTTP response header.
2) A list of HTTP/MIME headers used for the DASH Tuning-In Method is defined.
   a. A Dash-Tuning-In-Enable header is used to tell the receiver of this header whether the sender of this header enables the DASH Tuning-In Method. The DASH Tuning-In Method is enabled for a streaming session only when both the client and the server enable the method. The DASH Tuning-In Method is considered enabled for the sender of this header if and only if the value of this header is set to 1, and any other value or the absence of this header indicates that the DASH Tuning-In Method is disabled for the sender of this header.
   b. An Origin-Dash-Tuning-In-Segment header is used to notify which segment(s) should be included in the MIME multipart message when the DASH Tuning-In Method is in use. This header might be present multiple times in one HTTP response; in this case multiple segments should be included in the MIME multipart message.
      i. In one example, when using a CDN, the origin server may use this header to notify the CDN what segments should be included in the MIME multipart message when the DASH Tuning-In Method is in use. The CDN's edge server must place the files of these segments into MIME multipart message in the order listed in the Origin-Dash-Tuning-In-Segment header.
   c. A Dash-Tuning-In-File-Type header is used to tell client the file type. This makes it easier for a client to distinguish files within one MIME multipart message. The valid values are MPD (Media Presentation Description), IS (Initialization Segment) and MS (Media Segment).
      i. In one example, the server may notify the client what type the file is by adding this header into multipart message when the DASH Tuning-In Method is in use.
      ii. In one example, when using a CDN, the origin server may notify the CDN the file type using this HTTP header. And the CDN's edge server should carry the header to the client in the MIME multipart message when the DASH Tuning-In Method is in use.
   d. A list of HTTP/MIME headers used to signal the identifiers used in an URL, named Identifier headers, is defined.
      i. A Dash-Tuning-In-Identifier-Representation-Id header is used to signal the representation id identifier of the file.
      ii. A Dash-Tuning-In-Identifier-Number is used to signal the number identifier of the file.
      iii. A Dash-Tuning-In-Identifier-Time is used to signal the time identifier of the file.
      iv. A Dash-Tuning-In-Identifier-Bandwidth is used to signal the bandwidth identifier of the file.
      v. A Dash-Tuning-In-Identifier-Sub-Number is used to signal the sub number identifier of the file.
      vi. In one example, the server may notify the client the identifiers by adding Identifier headers into a multipart message when the DASH Tuning-In Method is in use.
      vii. In one example, when using a CDN, the origin server may notify the CDN the identifiers using Identifier headers. And the CDN's edge server should carry the Identifier headers to the client in the MIME multipart message when the DASH Tuning-In Method is in use.

### 5. EMBODIMENTS

Below are some example embodiments for some of the solution aspects summarized above in Section 4.

### 5.1 Embodiment 1

This embodiment is for items 1 and 2, for using the DASH Tuning-In Method without the use of a CDN.

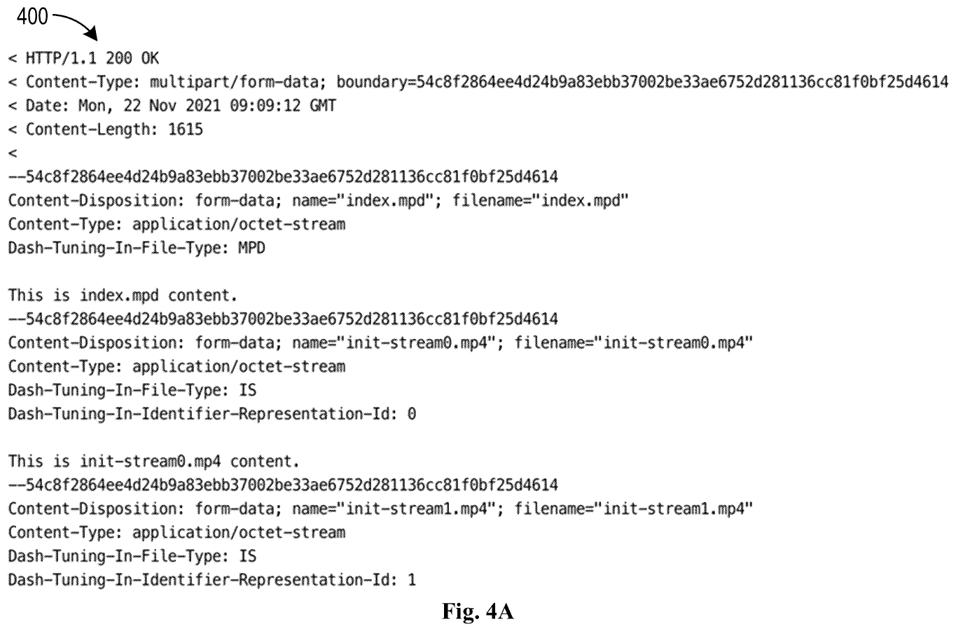

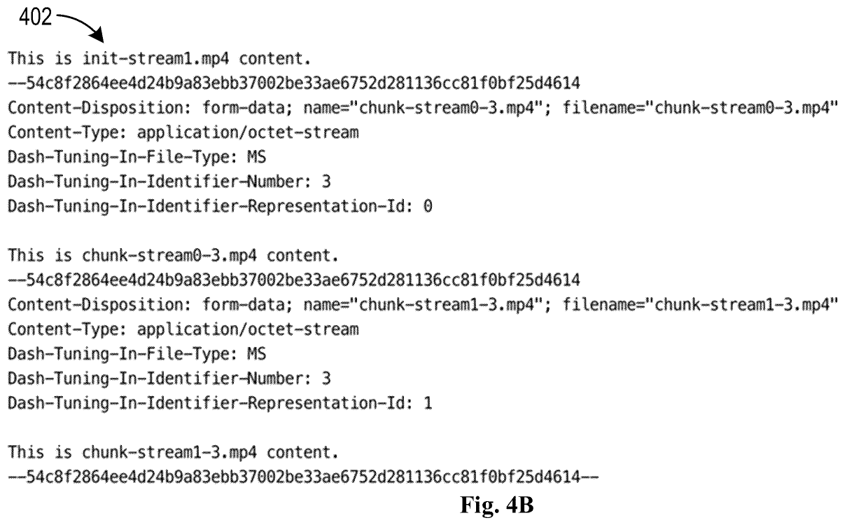

When the client starts to tune in to a live streaming session, it requests the MPD file with the HTTP header Dash-Tuning-In-Enable and the value of the HTTP header is set to 1. If the server accepts to use the DASH Tuning-In Method, it includes the HTTP header Dash-Tuning-In-Enable in the response and sets the value to 1, and includes the requested MPD file and other necessary files for tuning in within a MIME multipart message, such as IS files and MS files. For each file within the MIME multipart message, the server should notify the client the type of the file using the Dash-Tuning-In-File-Type header as well as the URL identifiers using the Identifier headers. FIGS. 4A and 4B show what a response of DASH Tuning-In Method looks like. An example of the DASH Tuning-In Method response is shown in FIGS. 4A and 4B. More specifically, FIG. 4A illustrates a first part 400 of the example of the DASH Tuning-In Method response, and FIG. 4B illustrates a second part 402 of the example of the DASH Tuning-In Method response. It is to be understood that the second part 402 follows the first part 400, and the example of the DASH Tuning-In Method response is shown in two parts just for purpose of illustration.

When the client receives the response, it should check whether the server enabled the DASH Tuning-In Method. If the DASH Tuning-In Method is enabled, the client parses the MIME multipart message, reads all files within the different parts of the MIME multipart message, and uses those files to initialize the player, and then derive the URLs of the subsequent MS files.

### 5.2 Embodiment 2

This is another embodiment for items 1 and 2, for using the DASH Tuning-In Method with the use of a CDN.

When the client starts to tune in to a live streaming session, it requests the MPD file with the HTTP header Dash-Tuning-In-Enable and value is set to 1. If the CDN's edge server accepts to use the DASH Tuning-In Method, it includes the HTTP header Dash-Tuning-In-Enable in the response and sets the value to 1, and includes the requested MPD file and other necessary files for tuning in within a MIME multipart message, such as IS files and MS files. For each file within the MIME multipart message, the server should notify the client the file type using the Dash-Tuning-In-File-Type header as well as the URL identifiers using the Identifier headers.

However, the CDN may not be able to decide what files should be included in the MIME multipart message. In this case, the origin server needs to notify the CDN what files should be included, by carrying the URLs of those files with the Origin-Dash-Tuning-In-Segment headers when the origin server sends a MPD file to the CDN. Then the CDN's edge server includes the files listed into the MIME multipart message in the order as they are listed in the Origin-Dash-Tuning-In-Segment headers. If any needed file is absent in the cache of the CDN's edge server, the edge server requests for that from the origin server. If any needed file is also absent in the origin server, then the edge server shall disable the DASH Tuning-In Method for this request by setting the Dash-Tuning-In-Enable header to 0 and sends the requested MPD file only.

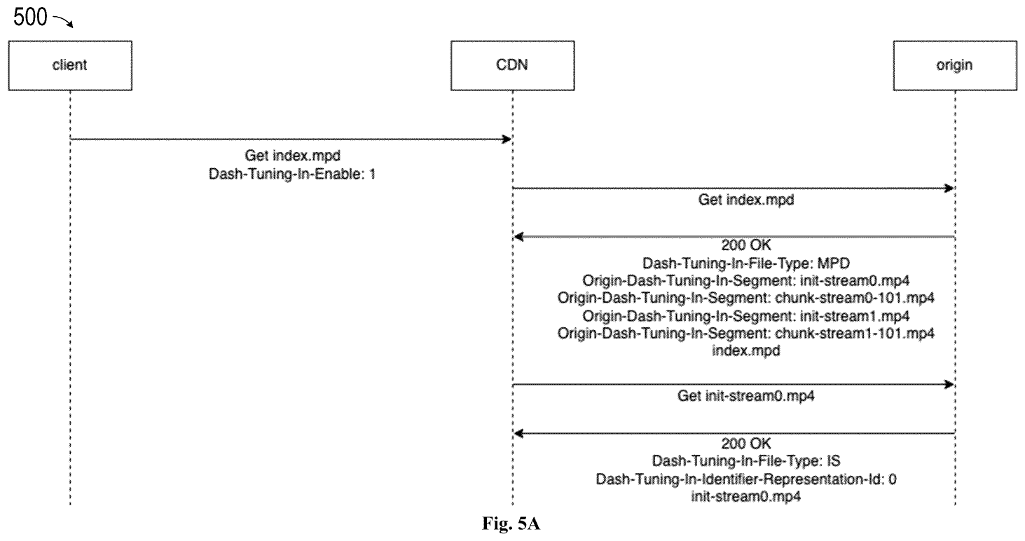

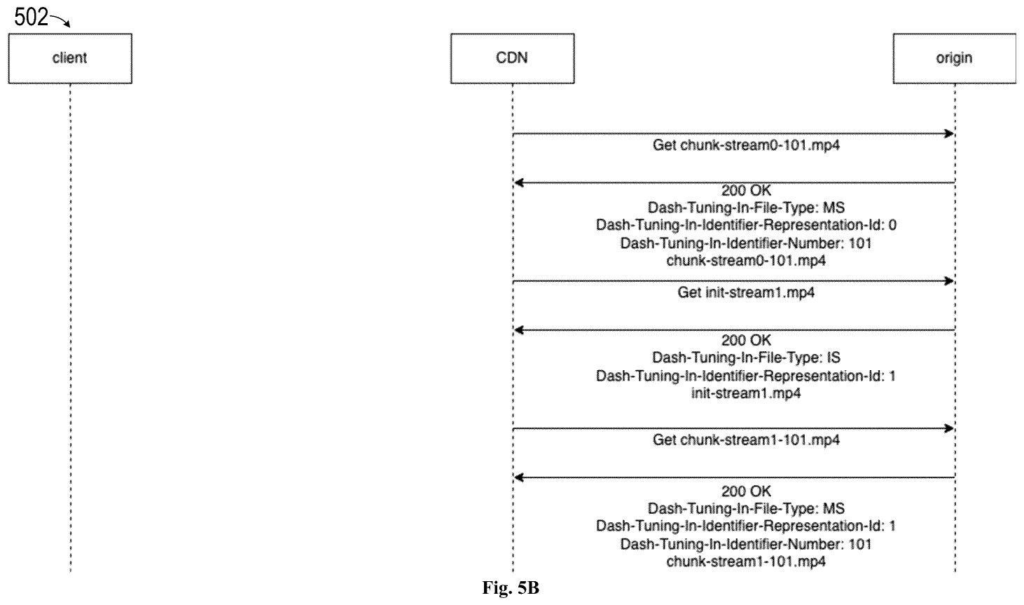

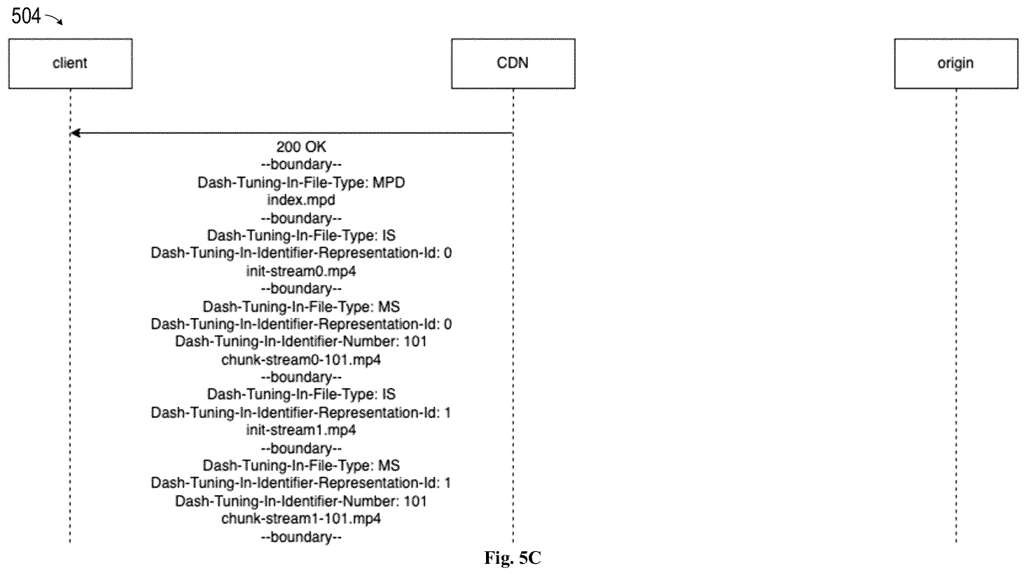

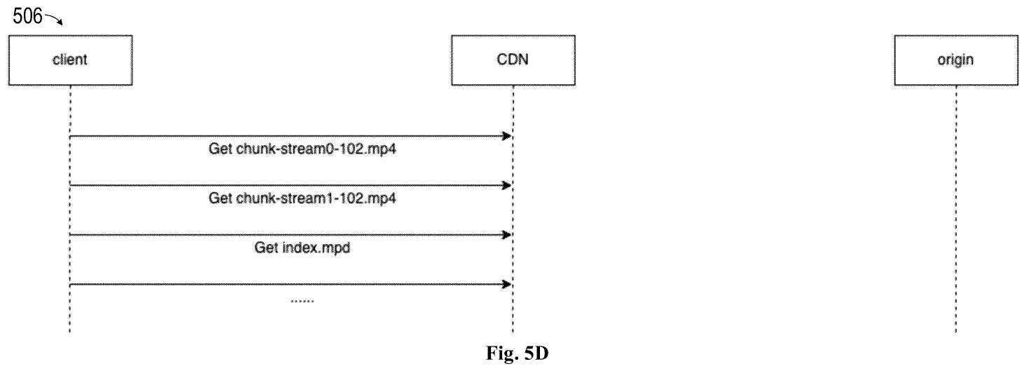

The CDN may not be able to know the types and the URL identifiers for those files. In this case, the origin server needs to send these to the CDN by using the Dash-Tuning-In-File-Type header and the Identifier headers when sending each file to the CDN. Then the CDN's edge server should include the Dash-Tuning-In-File-Type header and the Identifier headers into the multipart message headers, e.g., as shown in the example illustrated with respect to FIGS. 5A-5D. FIGS. 5A-5D, in combination, show the process of the DASH Tuning-In Method using a CDN when the needed files are not cached, and each illustrates one part of the example process. More specifically, FIGS. 5A-5D illustrate a first part 500, a second part 502, a third part 504 and a fourth part 506 of the example process of the DASH Tuning-In Method using the CDN when the needed files are not cached, respectively.

When the client receives a response, it should check whether the server and the CDN enabled DASH Tuning-In Method. If the DASH Tuning-In Method is enabled, the client parses the MIME multipart message, reads all files within the message, and uses those files to initialize the player, and then derive the URLs of the subsequent MSs.

More details of the embodiments of the present disclosure will be described below, which are related to hyper text transfer protocol (HTTP) header extensions for tuning in delay optimization in live media streaming.

As used herein, the term “media data file” may refer to a file associated with media data, such as video data and/or audio data. In the case of dynamic adaptive streaming over HTTP (DASH), the media data file may be a multimedia presentation description (MPD), an initialization segment (IS), a media segment (MS), and/or the like. It should be understood that the examples of the media data file described here are merely illustrative and therefore should not be construed as limiting the present disclosure in any way.

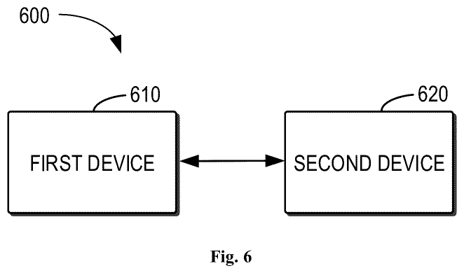

For purpose of discussion, FIG. 6 illustrates a schematic diagram of an example environment 600 in which techniques for media data transmission in accordance with some embodiments of the present disclosure can be implemented. As shown in FIG. 6, the environment 600 comprises a first device 610 and a second device 620. The first device 610 and the second device 620 may be communicatively coupled. By way of example rather than limitation, the first device 610 and the second device 620 may be coupled by a network, which may be the Internet.

In some embodiments, the first device 610 may be a client or a media data receiver. The term “client” used herein may refer to a piece of computer hardware or software that accesses a service made available by a server as part of the client-server model of computer networks. Only as an example, the first device 610 may be a mobile device, such as smartphone or a tablet.

In some embodiments, the second device 620 may be a server or a media data sender. The term “server” used herein may refer to a device capable of computing, in which case the client accesses the service by way of a network. Only as an example, the second device 620 may be a physical computing device or a virtual computing device.

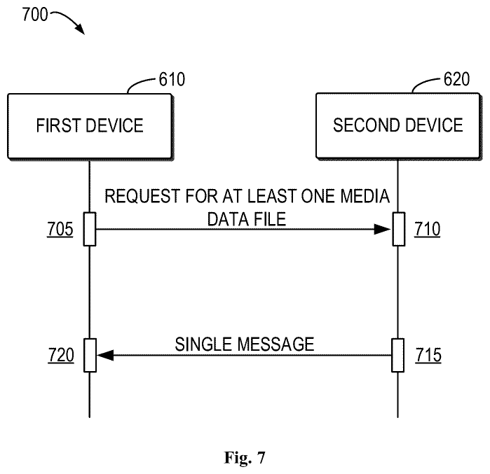

FIG. 7 illustrates a signaling chart 700 for media data transmission according to some embodiments of the present disclosure. The signaling chart 700 involves the first device 610, and the second device 620. By way of example rather than limitation, the first device 610 may be a client, and the second device 620 may be an origin device which prepares media data files, or an edge device in a content delivery network (CDN).

In operation, the first device 610 transmits 705 a request for at least one media data file to the second device 620. The request comprises a first indication indicating that a plurality of media data files are to be transmitted in a single message. In some embodiments, the at least one media data file may be a manifest file associated with the media data, such as an MPD. Additionally or alternatively, the at least one media data file may comprise any other suitable file, such as an IS or an MS. The scope of the present disclosure is not limited in this respect.

By way of example rather than limitation, the request may be a HTTP request, for example, a GET request. Furthermore, the first indication may be an HTTP header, e.g., a Dash-Tuning-In-Enable header. In one example, if the Dash-Tuning-In-Enable header is set to 1, it indicates that not only the requested MPD but also all other media data files that the first device 610 needs to tune into the live streaming service should be transmitted in a single message. It should be understood that the possible implementation of the first indication described here are merely illustrative and therefore should not be construed as limiting the present disclosure in any way.

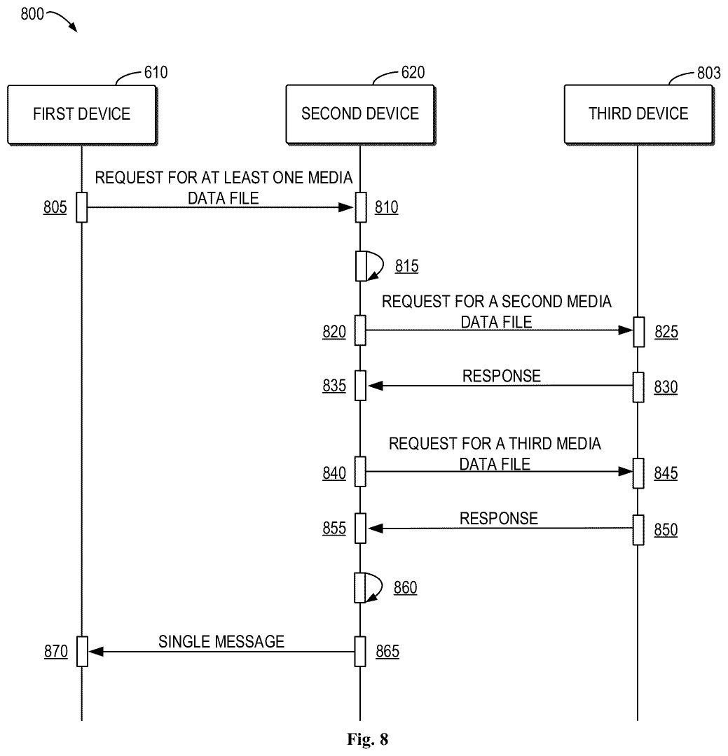

After receiving 710 the request from the first device 610, the second device 620 may load the plurality of media data files, if these plurality of media data files are available at the second device 620. In some cases, part of the plurality of media data files may be not available at the second device 620. By way of example rather than limitation, the second device 620 may be an edge device in the CDN and store or cache a subset of the media data files prepared by the origin device in the CDN. In this case, the second device 620 may retrieve the missing media data files from a third device, such as the origin device. This will be discussed in more detail with reference to FIG. 8 hereinafter. It should be understood that the plurality of media data files may be obtained in any other suitable manner. The scope of the present disclosure is not limited in this respect.

The second device 620 transmits 715 the plurality of media data files in a single message to the first device 610 as a response to the request for the at least one media data file. The first device 610 receives 720 the plurality of media data files in the single message.

As can be seen from the above description, a plurality of media data files can be transmitted in a single message as a response to a request for at least one media data file. Compared with the conventional solution where these media data files are requested and transmitted in more than one roundtrip, the proposed method can advantageously reduce the roundtrips and thus reduce the initialization delay, i.e., the tune in delay.

In some embodiments, the single message may be a multipurpose internet mail extensions (MIME) message. The MIME message may comprise a plurality of parts and the second device 620 may generate the MIME message by including the plurality of media data files into the MIME message as different parts. That is, each of the plurality of parts in the MIME message may comprise one of the plurality of media data files. Thereby, the plurality of media data files can be included in the single message in a well-organized manner. It should be noted that the single message may be any other suitable multipart message. The scope of the present disclosure is not limited in this respect.

In some additional embodiments, the single message may comprise a second indication indicating a file type of one of the plurality of media data files. In some examples, the second indication may be an HTTP header, e.g., a Dash-Tuning-In-File-Type header. By way of example, the valid values for the Dash-Tuning-In-File-Type header may comprise “MPD” for a media presentation description, “IS” for an initialization segment and “MS” for a media segment. Thereby, it is easier for the first device 610 to distinguish the media data files within the single message. It should be understood that second indication is an optional element rather than an essential clement for the single message and the above examples are described merely for purpose of description. The scope of the present disclosure is not limited in this respect.

Additionally, the single message may further comprise a set of indications for constructing a file identifier of a first media data file in the plurality of media data files. In one example, the file identifier may be a uniform resource locator (URL). In another example, the file identifier may be a uniform resource name (URN). In a further example, the file identifier may be a uniform resource identifier (URI). Additionally, the set of indications may be a set of HTTP headers, and the set of indications may also be referred to as identifier headers. It should be understood that this set of indications are optional elements rather than essential elements for the single message.

By way of example rather than limitation, the set of indication may comprise an indication (e.g., a Dash-Tuning-In-Identifier-Representation-Id header) indicating a representation identity (ID) identifier of the first media data file. The set of indication may further comprise an indication (e.g., a Dash-Tuning-In-Identifier-Number header) indicating a number identifier of the first media data file. In addition, the set of indication may comprise an indication (e.g., a Dash-Tuning-In-Identifier-Time header) indicating a time identifier of the first media data file. Moreover, the set of indication may comprise an indication (e.g., a Dash-Tuning-In-Identifier-Bandwidth header) indicating a bandwidth identifier of the first media data file. Additionally, the set of indication may comprise an indication (e.g., a Dash-Tuning-In-Identifier-Sub-Number header) indicating a sub number identifier of the first media data file. Thereby, the second device 620 can notify the first device 610 the identifiers used in a file identifier of a media data file, and thus the file identifier of the media data file can be constructed more efficiently. It should be understood that the above examples are described merely for purpose of description. The scope of the present disclosure is not limited in this respect.

In some further embodiments, the single message may comprise an eighth indication indicating that the plurality of media data files are transmitted in the single message. The eighth indication may be an HTTP header, e.g., a Dash-Tuning-In-Enable header. Thereby, the second device 620 can notify the first device 610 that the second device 620 also supports the proposed method of media data transmission, which may be also referred to as DASH Tuning-In Method. Correspondingly, upon receiving 720 the single message, the first device 610 may determine whether the single message comprises the eighth indication. If the single message comprises the eighth indication, the first device 610 may parse the single message, read the media data files within the message and use these files to initialize the media player and start playing.

In aid of the eighth indication, it is easier for the first device 610 to determine whether the second device 620 support the DASH Tuning-In Method, and thus the received message can be parsed more efficiently. It should be understood that the eighth indication is an optional element rather than an essential element for the single message and the above examples are described merely for purpose of description. The scope of the present disclosure is not limited in this respect.

FIG. 8 illustrates another signaling chart 800 for media data transmission according to some embodiments of the present disclosure. The signaling chart 800 involves the first device 610, the second device 620 and the third device 803. By way of example rather than limitation, the first device 610 may be a client, the second device 620 may be an edge device in a CDN, and the third device 803 may be an origin device in the CDN. The edge device may be located closer to the client than the origin device.

In operation, the first device 610 transmits 805 a request for at least one media data file to the second device 620, for example, when the first device 610 tunes into a live streaming service. The request comprises the same first indication as described with respect to FIG. 7. After receiving 810 the request, the second device 620 may determine 815 whether each of the plurality of media data files is available at the second device 620. For example, the second device 620 may check whether each of the plurality of media data files is stored in a storage device (e.g., a cache) of the second device 620. If it is determined that a requested media data file is stored in the storage device, the second device 620 may load the requested media data file from the storage device.

For case of discussion, it is assumed that a second media data file and a third media data file in the plurality of media data files are not available at the second device 620. In such a case, the second device 620 may transmit 820 a request for the second media data file to the third device 803. After receiving 825 the request from the second device 620, the third device 803 may transmit 830 a response to the second device 620. The response may comprise the requested second media data file.

In some embodiments, if the second device 620 is not able to determine which media data files should be included in the single message to be transmitted from the second device 620 to the first device 610, the third device 803 may notify the second device 620 the media data files to be included in the single message in some ways, including but not limited to carrying a ninth indication within the response. For example, the ninth indication may be an HTTP header, e.g., an Origin-Dash-Tuning-In-Segment header. In one example, the Origin-Dash-Tuning-In-Segment header may comprise the URLs of a set of media data files to be transmitted from the second device 620 to the first device 610 in the single message. Alternatively, the Origin-Dash-Tuning-In-Segment header may be present more than one time in the response, so as to indicate that more than one media data file should be transmitted from the second device 620 to the first device 610 in the single message. Thereby, the second device 620 can transmit the plurality of the media data files that the first device 610 needed in a single message, so as to optimize the tune in delay.

In some additional embodiments, the response may further comprise an indication (e.g., a Dash-Tuning-In-File-Type header) indicating the file type of the second media data file, so as to notify the second device 620 the type of the second media data file. Additionally or alternatively, the response may comprise an indication (e.g., an identifier header) for constructing a file identifier of the second media data file, so as to notify the second device 620 which identifier should be used to construct the file identifier of the second media data file. It should be understood that the above illustrations are described merely for purpose of description. The scope of the present disclosure is not limited in this respect.

After receiving 835 the second media data file, the second device 620 may further transmit 840 a request for the third media data file to the third device 803. Upon receiving 845 this request, the third device 803 may transmit 850, to the second device 620, a response to the request, which may comprise, for example, the third media data file and an indication (e.g., a Dash-Tuning-In-File-Type header) indicating the file type of the third media data file.

After receiving 855 the third media data file from the third device 803, the second device 620 may generate 860 the single message by including the plurality of media data files in the single message as different parts. In some embodiments, if the response received 835 from the third device 803 comprise the Origin-Dash-Tuning-In-Segment header indicating the plurality of media data files to be included in the single message, the second device 620 may include the plurality of media data files in the single message in an order indicated in the Origin-Dash-Tuning-In-Segment header, so as to ensure the single message is well-organized and facilitate the parsing of the single message.

The second device 620 transmits 865 the single message to the first device 610. Upon receiving 870 the single message, the first device 610 may parse the single message, read the media data files within the message and use these files to initialize the media player and start playing.

Although two example processes for media data transmission are described above with respect to FIGS. 7 and 8, it should be noted that any other suitable variants of the media data transmission process are also conceivable in view of the present disclosure. By way of example, the requested at least one media data file may be transmitted to the first device 610 at first, and then the plurality of media data files may be transmitted to the first device 610 in a single message. The scope of the present disclosure is not limited in this respect.

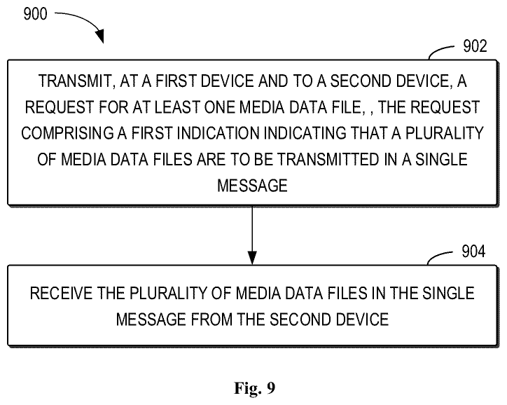

FIG. 9 illustrates a flowchart of a method 900 of media data transmission in accordance with some embodiments of the present disclosure. For the purpose of discussion, the method 900 will be described from the perspective of the first device 610 shown in FIG. 6.

At 902, the first device 610 transmits a request for at least one media data file to a second device 620. The request comprises a first indication indicating that a plurality of media data files are to be transmitted in a single message. In some embodiments, the at least one media data file may comprise an MPD. The plurality of media data files may comprise at least one of the following: the MPD, an IS, or an MS.

At 904, the first device 610 receives the plurality of media data files in the single message from the second device 620. In some embodiments, the first device 610 may receive the plurality of media data files in an MIME message. For example, the MIME message may comprise a plurality of parts. Each part may comprise one of the plurality of media data files.

In some embodiments, the single message may comprise a second indication indicating a file type of one of the plurality of media data files. Additionally or alternatively, the single message may comprise a set of indications for constructing a file identifier of a first media data file in the plurality of media data files. In one example, the file identifier may be a URL.

By way of example rather than limitation, the set of indications may comprise at least one of the following: a third indication indicating a representation ID identifier of the first media data file, a fourth indication indicating a number identifier of the first media data file, a fifth indication indicating a time identifier of the first media data file, a sixth indication indicating a bandwidth identifier of the first media data file, or a seventh indication indicating a sub number identifier of the first media data file. In some embodiments, the first indication, the second indication and the set of indications may be HTTP headers.

In some embodiments, the first device 610 may determine whether the single message comprises an eighth indication. The eighth indication indicates that the plurality of media data files are transmitted in the single message. In accordance with a determination that the single message comprises the eighth indication, the first device 610 may obtain the plurality of media data files by parsing the single message.

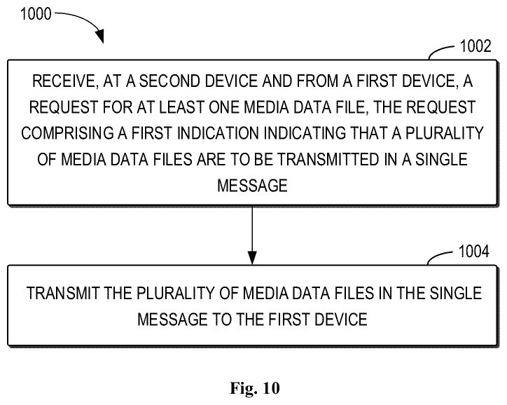

FIG. 10 illustrates a flowchart of another method 1000 of media data transmission in accordance with some embodiments of the present disclosure. For the purpose of discussion, the method 1000 will be described from the perspective of the second device 620 shown in FIG. 6.

At 1002, the second device 620 receives a request for at least one media data file from the first device 610. The request comprises a first indication indicating that a plurality of media data files are to be transmitted in a single message. In some embodiments, the at least one media data file may comprise an MPD. The plurality of media data files may comprise at least one of the following: the MPD, an IS, or an MS.

At 1004, the second device 620 transmits the plurality of media data files in the single message to the first device 610. In some embodiments, the second device 620 may transmit the plurality of media data files in an MIME message. For example, the MIME message may comprise a plurality of parts, each part may comprise one of the plurality of media data files.

In some embodiments, the second device 620 may determine whether a second media data file in the plurality of media data files is available at the second device 620. In accordance with a determination that the second media data file is available at the second device 620, the second device 620 may generate the single message based on the second media data file. In accordance with a determination that the second media data file is unavailable at the second device 620, the second device 620 may transmit a request for the second media data file to a third device to which the second media data file is available. The second device 620 may receive a response may comprise the second media data file from the third device, and generate the single message based on the second media data file.

In some embodiments, the response may further comprise a ninth indication indicating a set of media data files may comprise the plurality of media data files. For example, the ninth indication may be a HTTP header, and the HTTP header may comprise file identifiers of the set of media data files. The plurality of media data files may be included in the single message in an order indicated in the ninth indication. Additionally or alternatively, the response may further comprise a tenth indication indicating a file type of the second media data file. In some further embodiments, the response may further comprise an eleventh indication for constructing a file identifier of the second media data file.

In some embodiments, the single message may comprise a second indication indicating a file type of one of the plurality of media data files. Additionally or alternatively, the single message may comprise a set of indications for constructing a file identifier of a first media data file in the plurality of media data files. In one example, the file identifier may be a URL.

By way of example rather than limitation, the set of indications may comprise at least one of the following: a third indication indicating a representation ID identifier of the first media data file, a fourth indication indicating a number identifier of the first media data file, a fifth indication indicating a time identifier of the first media data file, a sixth indication indicating a bandwidth identifier of the first media data file, or a seventh indication indicating a sub number identifier of the first media data file. In some further embodiments, the single message may comprise an eighth indication indicating that the plurality of media data files are transmitted in the single message. In some embodiments, the first indication, the second indication and the set of indications may be HTTP headers.

Implementations of the present disclosure can be described in view of the following clauses, the features of which can be combined in any reasonable manner.

Clause 1. A method of media data transmission, comprising: transmitting, at a first device and to a second device, a request for at least one media data file, the request comprising a first indication indicating that a plurality of media data files are to be transmitted in a single message; and receiving the plurality of media data files in the single message from the second device.

Clause 2. The method of clause 1, wherein the at least one media data file comprises a multimedia presentation description (MPD), and the plurality of media data files comprise at least one of the following: the MPD, an initialization segment (IS), or a media segment (MS).

Clause 3. The method of any of clauses 1-2, wherein receiving the plurality of media data files in the single message comprises: receiving the plurality of media data files in a multipurpose internet mail extensions (MIME) message.

Clause 4. The method of clause 3, wherein the MIME message comprises a plurality of parts, each part comprising one of the plurality of media data files.

Clause 5. The method of any of clauses 1-4, wherein the single message comprises a second indication indicating a file type of one of the plurality of media data files.

Clause 6. The method of any of clauses 1-5, wherein the single message comprises a set of indications for constructing a file identifier of a first media data file in the plurality of media data files.

Clause 7. The method of clause 6, wherein the file identifier is a uniform resource locator (URL).

Clause 8. The method of any of clauses 6-7, wherein the set of indications comprise at least one of the following: a third indication indicating a representation identity (ID) identifier of the first media data file, a fourth indication indicating a number identifier of the first media data file, a fifth indication indicating a time identifier of the first media data file, a sixth indication indicating a bandwidth identifier of the first media data file, or a seventh indication indicating a sub number identifier of the first media data file.

Clause 9. The method of any of clauses 6-8, wherein the first indication, the second indication and the set of indications are hyper text transfer protocol (HTTP) headers.

Clause 10. The method of any of clauses 1-9, further comprising: determining whether the single message comprises an eighth indication indicating that the plurality of media data files are transmitted in the single message; and in accordance with a determination that the single message comprises the eighth indication, obtaining the plurality of media data files by parsing the single message.

Clause 11. A method of media data transmission, comprising: receiving, at a second device and from a first device, a request for at least one media data file, the request comprising a first indication indicating that a plurality of media data files are to be transmitted in a single message; and transmitting the plurality of media data files in the single message to the first device.

Clause 12. The method of clause 11, wherein the at least one media data file comprises a multimedia presentation description (MPD), and the plurality of media data files comprise at least one of the following: the MPD, an initialization segment (IS), or a media segment (MS).

Clause 13. The method of any of clauses 11-12, wherein transmitting the plurality of media data files in the single message comprises: transmitting the plurality of media data files in a multipurpose internet mail extensions (MIME) message.

Clause 14. The method of clause 13, wherein the MIME message comprises a plurality of parts, each part comprising one of the plurality of media data files.

Clause 15. The method of any of clauses 11-14, wherein the second device comprises an edge device of a content delivery network (CDN) for media data transmission.

Clause 16. The method of any of clauses 11-15, further comprising: determining whether a second media data file in the plurality of media data files is available at the second device; in accordance with a determination that the second media data file is available at the second device, generating the single message based on the second media data file; and in accordance with a determination that the second media data file is unavailable at the second device, transmitting a request for the second media data file to a third device to which the second media data file is available, receiving a response comprising the second media data file from the third device, and generating the single message based on the second media data file.

Clause 17. The method of clause 16, wherein the response further comprises a ninth indication indicating a set of media data files comprising the plurality of media data files.

Clause 18. The method of clause 17, wherein the ninth indication is a HTTP header, and the HTTP header comprises file identifiers of the set of media data files.

Clause 19. The method of any of clauses 17-18, wherein the plurality of media data files are included in the single message in an order indicated in the ninth indication.

Clause 20. The method of any of clauses 16-19, wherein the response further comprises a tenth indication indicating a file type of the second media data file.

Clause 21. The method of any of clauses 16-20, wherein the response further comprises an eleventh indication for constructing a file identifier of the second media data file.

Clause 22. The method of any of clauses 11-21, wherein the single message comprises a second indication indicating a file type of one of the plurality of media data files.

Clause 23. The method of any of clauses 11-22, wherein the single message comprises a set of indications for constructing a file identifier of a first media data file in the plurality of media data files.

Clause 24. The method of clause 23, wherein the file identifier is a uniform resource locator (URL).

Clause 25. The method of any of clauses 23-24, wherein the set of indications comprise at least one of the following: a third indication indicating a representation identity (ID) identifier of the first media data file, a fourth indication indicating a number identifier of the first media data file, a fifth indication indicating a time identifier of the first media data file, a sixth indication indicating a bandwidth identifier of the first media data file, or a seventh indication indicating a sub number identifier of the first media data file.

Clause 26. The method of any of clauses 22-25, wherein the first indication, the second indication and the set of indications are HTTP headers.

Clause 27. The method of any of clauses 11-26, wherein the single message comprises an eighth indication indicating that the plurality of media data files are transmitted in the single message.

Clause 28. An apparatus for processing video data comprising a processor and a non-transitory memory with instructions thereon, wherein the instructions upon execution by the processor, cause the processor to perform a method in accordance with any of clauses 1-27.

Clause 29. A non-transitory computer-readable storage medium storing instructions that cause a processor to perform a method in accordance with any of clauses 1-27.

### Example Device

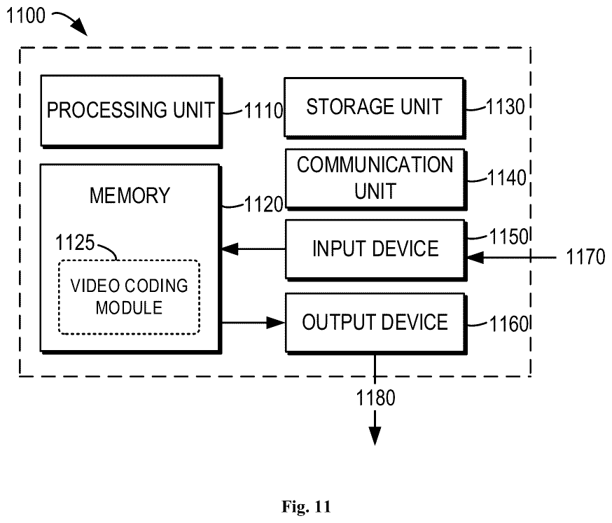

FIG. 11 illustrates a block diagram of a computing device 1100 in which various embodiments of the present disclosure can be implemented. The computing device 1100 may be implemented as or included in the source device 110 (or the video encoder 114 or 200) or the destination device 120 (or the video decoder 124 or 300).

It would be appreciated that the computing device 1100 shown in FIG. 11 is merely for purpose of illustration, without suggesting any limitation to the functions and scopes of the embodiments of the present disclosure in any manner.

As shown in FIG. 11, the computing device 1100 includes a general-purpose computing device 1100. The computing device 1100 may at least comprise one or more processors or processing units 1110, a memory 1120, a storage unit 1130, one or more communication units 1140, one or more input devices 1150, and one or more output devices 1160.

In some embodiments, the computing device 1100 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1100 can support any type of interface to a user (such as “wearable” circuitry and the like).

The processing unit 1110 may be a physical or virtual processor and can implement various processes based on programs stored in the memory 1120. In a multi-processor system, multiple processing units execute computer executable instructions in parallel so as to improve the parallel processing capability of the computing device 1100. The processing unit 1110 may also be referred to as a central processing unit (CPU), a microprocessor, a controller or a microcontroller.

The computing device 1100 typically includes various computer storage medium. Such medium can be any medium accessible by the computing device 1100, including, but not limited to, volatile and non-volatile medium, or detachable and non-detachable medium. The memory 1120 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1130 may be any detachable or non-detachable medium and may include a machine-readable medium such as a memory, flash memory drive, magnetic disk or another other media, which can be used for storing information and/or data and can be accessed in the computing device 1100.

The computing device 1100 may further include additional detachable/non-detachable, volatile/non-volatile memory medium. Although not shown in FIG. 11, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1140 communicates with a further computing device via the communication medium. In addition, the functions of the components in the computing device 1100 can be implemented by a single computing cluster or multiple computing machines that can communicate via communication connections. Therefore, the computing device 1100 can operate in a networked environment using a logical connection with one or more other servers, networked personal computers (PCs) or further general network nodes.

The input device 1150 may be one or more of a variety of input devices, such as a mouse, keyboard, tracking ball, voice-input device, and the like. The output device 1160 may be one or more of a variety of output devices, such as a display, loudspeaker, printer, and the like. By means of the communication unit 1140, the computing device 1100 can further communicate with one or more external devices (not shown) such as the storage devices and display device, with one or more devices enabling the user to interact with the computing device 1100, or any devices (such as a network card, a modem and the like) enabling the computing device 1100 to communicate with one or more other computing devices, if required. Such communication can be performed via input/output (I/O) interfaces (not shown).

In some embodiments, instead of being integrated in a single device, some or all components of the computing device 1100 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1100 may be used to implement video encoding/decoding in embodiments of the present disclosure. The memory 1120 may include one or more video coding modules 1125 having one or more program instructions. These modules are accessible and executable by the processing unit 1110 to perform the functionalities of the various embodiments described herein.

In the example embodiments of performing video encoding, the input device 1150 may receive video data as an input 1170 to be encoded. The video data may be processed, for example, by the video coding module 1125, to generate an encoded bitstream. The encoded bitstream may be provided via the output device 1160 as an output 1180.

In the example embodiments of performing video decoding, the input device 1150 may receive an encoded bitstream as the input 1170. The encoded bitstream may be processed, for example, by the video coding module 1125, to generate decoded video data. The decoded video data may be provided via the output device 1160 as the output 1180.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of media data transmission, comprising:
transmitting, at a first device and to a second device, a request for at least one media data file, the request comprising a first indication indicating that a plurality of media data files are to be transmitted in a single message; and
receiving the plurality of media data files in the single message from the second device.

2. The method of claim 1, wherein the at least one media data file comprises a multimedia presentation description (MPD), and the plurality of media data files comprise at least one of the following: the MPD, an initialization segment (IS), or a media segment (MS), or
wherein the single message comprises a second indication indicating a file type of one of the plurality of media data files.

3. The method of claim 1, wherein receiving the plurality of media data files in the single message comprises:
receiving the plurality of media data files in a multipurpose internet mail extensions (MIME) message.

4. The method of claim 3, wherein the MIME message comprises a plurality of parts, each part comprising one of the plurality of media data files.

5. The method of claim 1, wherein the single message comprises a set of indications for constructing a file identifier of a first media data file in the plurality of media data files.

6. The method of claim 5, wherein the file identifier is a uniform resource locator (URL), or
wherein the set of indications comprise at least one of the following:
a third indication indicating a representation identity (ID) identifier of the first media data file,
a fourth indication indicating a number identifier of the first media data file,
a fifth indication indicating a time identifier of the first media data file,
a sixth indication indicating a bandwidth identifier of the first media data file, or
a seventh indication indicating a sub number identifier of the first media data file, or
wherein the first indication, the second indication and the set of indications are hyper text transfer protocol (HTTP) headers.

7. The method of claim 1, further comprising:
determining whether the single message comprises an eighth indication indicating that the plurality of media data files are transmitted in the single message; and
in accordance with a determination that the single message comprises the eighth indication, obtaining the plurality of media data files by parsing the single message.

8. A method of media data transmission, comprising:
receiving, at a second device and from a first device, a request for at least one media data file, the request comprising a first indication indicating that a plurality of media data files are to be transmitted in a single message; and
transmitting the plurality of media data files in the single message to the first device.

9. The method of claim 8, wherein the at least one media data file comprises a multimedia presentation description (MPD), and the plurality of media data files comprise at least one of the following: the MPD, an initialization segment (IS), or a media segment (MS), or
the second device comprises an edge device of a content delivery network (CDN) for media data transmission, or
the single message comprises an eighth indication indicating that the plurality of media data files are transmitted in the single message.

10. The method of claim 8, wherein transmitting the plurality of media data files in the single message comprises:
transmitting the plurality of media data files in a multipurpose internet mail extensions (MIME) message.

11. The method of claim 10, wherein the MIME message comprises a plurality of parts, each part comprising one of the plurality of media data files.

12. The method of claim 8, further comprising:
determining whether a second media data file in the plurality of media data files is available at the second device;
in accordance with a determination that the second media data file is available at the second device, generating the single message based on the second media data file; and
in accordance with a determination that the second media data file is unavailable at the second device,
transmitting a request for the second media data file to a third device to which the second media data file is available,
receiving a response comprising the second media data file from the third device, and
generating the single message based on the second media data file.

13. The method of claim 12, wherein the response further comprises a ninth indication indicating a set of media data files comprising the plurality of media data files, or
wherein the response further comprises a tenth indication indicating a file type of the second media data file, or
the response further comprises an eleventh indication for constructing a file identifier of the second media data file.

14. The method of claim 13, wherein the ninth indication is an HTTP header, and the HTTP header comprises file identifiers of the set of media data files, or
wherein the plurality of media data files are included in the single message in an order indicated in the ninth indication.

15. The method of claim 8, wherein the single message comprises a second indication indicating a file type of one of the plurality of media data files, or
wherein the single message comprises a set of indications for constructing a file identifier of a first media data file in the plurality of media data files.

16. The method of claim 15, wherein the file identifier is a uniform resource locator (URL), or
wherein the set of indications comprise at least one of the following:
a third indication indicating a representation identity (ID) identifier of the first media data file,
a fourth indication indicating a number identifier of the first media data file,
a fifth indication indicating a time identifier of the first media data file,
a sixth indication indicating a bandwidth identifier of the first media data file, or
a seventh indication indicating a sub number identifier of the first media data file, or
wherein the first indication, the second indication and the set of indications are HTTP headers.

17. An apparatus for processing video data comprising a processor and a non-transitory memory with instructions thereon, wherein the instructions upon execution by the processor, cause the processor to perform acts comprising:
transmitting, at a first device and to a second device, a request for at least one media data file, the request comprising a first indication indicating that a plurality of media data files are to be transmitted in a single message; and
receiving the plurality of media data files in the single message from the second device.

18. A non-transitory computer-readable storage medium storing instructions that cause a processor to perform acts comprising:
transmitting, at a first device and to a second device, a request for at least one media data file, the request comprising a first indication indicating that a plurality of media data files are to be transmitted in a single message; and
receiving the plurality of media data files in the single message from the second device.

19. An apparatus for processing video data comprising a processor and a non-transitory memory with instructions thereon, wherein the instructions upon execution by the processor, cause the processor to perform acts comprising:
receiving, at a second device and from a first device, a request for at least one media data file, the request comprising a first indication indicating that a plurality of media data files are to be transmitted in a single message; and
transmitting the plurality of media data files in the single message to the first device.

20. A non-transitory computer-readable storage medium storing instructions that cause a processor to perform acts comprising:
receiving, at a second device and from a first device, a request for at least one media data file, the request comprising a first indication indicating that a plurality of media data files are to be transmitted in a single message; and
transmitting the plurality of media data files in the single message to the first device.
